(19) United States
(12) Patent Application Publication
(10) Pub. No.: US 2014/0359198 A1
(43) Pub. Date: Dec. 4, 2014

(54) NOTIFICATION OF STORAGE DEVICE PERFORMANCE TO HOST

(71) Applicant: Apple Inc., Cupertino, CA (US)

(72) Inventors: Etai Zaltsman, Ramat-Hasaron (IL); Ori Moshe Stern, Modi'in (IL); Sasha Paley, Kfar-Saba (IL)

(73) Assignee: Apple Inc., Cupertino, CA (US)

(21) Appl. No.: 13/903,298

(22) Filed: May 28, 2013

(51) Int. Cl. G06F 12/02

(52) U.S. Cl. CPC G06F 12/0246
USPC 711/103

(57) ABSTRACT

A method includes, in a storage device that stores data for a host in a memory, estimating an impact of an amount of free memory space in the memory on a storage performance of the storage device. The storage device sends to the host a notification that is indicative of the estimated impact.

### FIELD OF THE INVENTION

The present invention relates generally to memory systems, and particularly to methods for managing data in storage devices.

### SUMMARY OF THE INVENTION

An embodiment of the present invention described herein provides a method including, in a storage device that stores data for a host in a memory, estimating an impact of an amount of free memory space in the memory on a storage performance of the storage device. The storage device sends to the host a notification that is indicative of the estimated impact.

In some embodiments, estimating the impact includes estimating a write amplification overhead occurring in the memory. In other embodiments, estimating the impact includes assessing a number of bad memory blocks in the memory. In yet other embodiments, estimating the impact includes estimating an over-provisioning overhead in the memory. In some embodiments, estimating the impact includes estimating an extent of fragmentation in the data stored in the memory.

In some embodiments, sending the notification includes sending an indication of whether the storage performance is adequate. In yet other embodiments, sending the notification includes sending to the host a first notification indicative of the amount of free memory space, and a second notification indicative of the impact of the amount of free memory space on the storage performance.

In some embodiments, the method includes, in the host, deleting one or more data items from the storage device in response to the notification. In other embodiments, the method includes, in response to the notification, sending from the host to the storage device a trim command that frees specified addresses in the storage device. In yet other embodiments, the method includes, in response to the notification, rewriting data to sequential memory pages in the memory so as to reduce fragmentation in the storage device.

There is additionally provided, in accordance with the embodiments of the present invention, a storage device including a memory and a processor. The processor is configured to store data for a host in the memory, to estimate an impact of an amount of free memory space in the memory on a storage performance of the storage device, and to send to the host a notification that is indicative of the estimated impact.

There is additionally provided herein, in accordance with the embodiments of the present invention, a host including a storage interface for communicating with a storage device, and a processor. The processor is configured to store data in a memory of the storage device, to receive from the storage device a notification that is indicative of an estimated impact of an amount of free memory space in the memory on a storage performance of the storage device, and to selectively delete one or more data items from the storage device in response to the notification.

There is additionally provided herein, in accordance with the embodiments of the present invention, an apparatus including a host and a storage device. The storage device, which includes a memory and is configured to store in the memory data for the host, to estimate an impact of an amount of free memory space in the memory on a storage performance of the storage device, and to send to the host a notification that is indicative of the estimated impact, so as to cause the host to selectively delete one or more data items from the storage device in response to the notification.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a host storing data in a storage device, in accordance with an embodiment of the present invention; and FIG. 2 is a flow chart that schematically illustrates a method for managing data storage, in accordance with an embodiment of the present invention.

### DETAILED DESCRIPTION OF EMBODIMENTS

### Overview

When a host sends data items for storage on a storage device, such as a Solid State Drive (SSD), the host does not have complete information regarding the storage performance of the storage device. The host is typically aware of the amount of free memory space on the storage device, but the amount of free memory space does not necessarily reflect the storage device performance. For example, if the data stored on the storage device is heavily fragmented, storage performance (e.g., latency) may be poor even when there is large memory space available. At the other extreme, even when the storage device is nearly full, its storage performance may still be adequate if the data is arranged efficiently.

Embodiments of the present invention that are described herein provide improved methods and systems for monitoring and acting upon the true storage performance of the storage device. In the disclosed embodiments, the storage device estimates the impact of the free memory space on its storage performance, and sends to the host a notification that is indicative of the estimated impact. The host may respond to this notification, for example, by deleting one or more files from the storage device or by issuing a “trim” command that frees memory space.

The storage device may estimate the impact of the free memory space on storage performance in various ways, for example by assessing the write amplification ratio, the number of bad memory blocks, the over-provisioning ratio, or the extent of data fragmentation. These example measures are explained in detail below. The notification from the storage drive to the host may comprise, for example, an indication of one or more such measures, or a flag indicating whether storage performance is adequate or not.

By using the disclosed techniques, the host is provided with richer information regarding the true storage performance of the storage device, beyond the mere indication of free memory space. The richer information enables the host to manage the storage device more efficiently. For example, when the storage device is far from full but its storage performance is poor, the disclosed techniques enable the host to free memory space and thus improve storage performance. As another example, when the storage device is nearly full but its storage performance is still adequate, the disclosed techniques enable the host to refrain from taking worst-case performance margins, and thus increase storage capacity.

### System Description

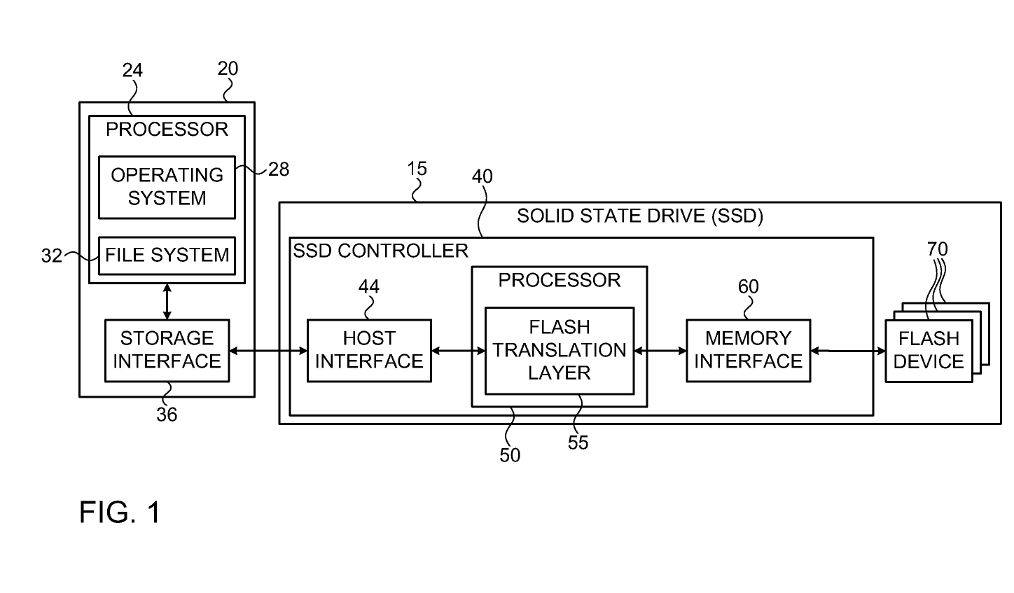

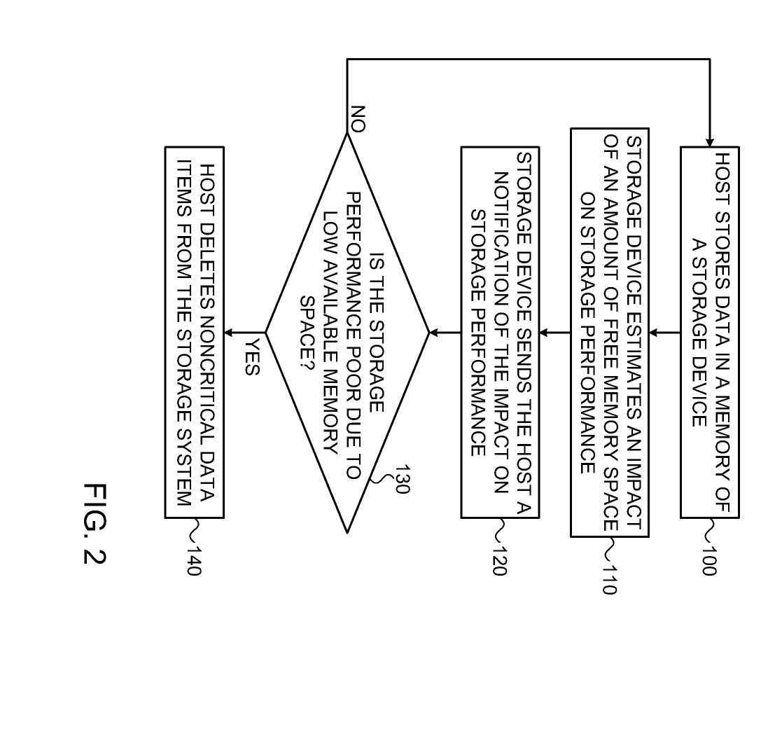

FIG. 1 is a block diagram that schematically illustrates a host 20 storing data in a storage device 15, in accordance with an embodiment of the present invention. Hosts that store data on storage devices with non-volatile storage devices may comprise, for example, personal computers, enterprise storage controllers, mobile phones, digital cameras, media players, removable memory cards or devices, and many others.

Host 20 comprises a central processing unit (CPU) 24. CPU 24 runs an operating system (OS) 28 that is typically programmed in software and carries out the functions of the host. Operating system 28 comprises a file system 32, which manages storage of files whose data is stored in storage device 15. In particular, file system 32 records the logical addresses (e.g., Logical Block Addresses—LBAs) in which each file is stored on storage device 15. The file system communicates with storage device 15 via a storage interface 36.

In the example embodiments described herein, storage device 15 comprises a solid state drive (SSD). SSD 15 comprises an SSD controller 40 that relays data between host 20 and one or more Flash memory devices 70, and manages data storage in the SSD. Controller 40 comprises a host interface 44 for communicating with host 20, a processor 50 that carries out the disclosed management techniques, and a memory interface 60 for communicating with Flash devices 70.

Processor 50 comprises a Flash translation layer (FTL) 55, which manages a Logical-to-Physical (L2P) address mapping. The L2P mapping maps the LBAs to respective physical addresses, i.e., physical storage locations in the memory cell blocks of Flash devices 70 where the data is stored.

In the present example, the non-volatile memory of SSD 15 comprises one or more NAND Flash memory devices 70. In alternative embodiments, the non-volatile memory in SSD 15 may comprise any other suitable type of non-volatile memory, such as, for example, NOR Flash, Charge Trap Flash (CTF), Phase Change RAM (PRAM), Magneto-resistive RAM (MRAM) or Ferroelectric RAM (FeRAM).

The configuration of FIG. 1 is an exemplary configuration, which is shown purely for the sake of conceptual clarity, and not by way of limitation of the embodiments of the present invention. Any other suitable host and/or storage device configuration can also be used. In the exemplary system configuration shown in FIG. 1, memory devices 70 and SSD controller 40 are implemented as separate Integrated Circuits (ICs). In alternative embodiments, however, the memory devices and the SSD controller may be integrated on separate semiconductor dies in a single Multi-Chip Package (MCP) or System on Chip (SoC), and may be interconnected by an internal bus. Further alternatively, some or all of the SSD controller circuitry may reside on the same die on which one or more of memory devices 70 are disposed. Further alternatively, some or all of the functionality of SSD controller 40 can be implemented in software and carried out by CPU 24 or other processor in the host. In some embodiments, CPU 24 and SSD controller 40 may be fabricated on the same die, or on separate dies in the same device package.

Processor 50 of SSD controller 40 and/or CPU 24 may be implemented in hardware. Alternatively, the SSD controller and/or CPU may comprise a microprocessor that runs suitable software, or a combination of hardware and software elements. In some embodiments, processor 50 and/or CPU 24 comprises a general-purpose processor, which is programmed in software to carry out the functions described herein. The software may be downloaded to the processor in electronic form, over a network, for example, or it may, alternatively or additionally, be provided and/or stored on non-transitory tangible media, such as magnetic, optical, or electronic memory.

During the operation of SSD 15, as the memory blocks in Flash devices 70 become full and the amount of free memory space decreases, SSD 15 operates more inefficiently. Moreover, the arrangement of data pages within the memory blocks of Flash devices 70 also affects the storage performance. For example, if the data pages are stored sequentially into the memory blocks with minimal fragmentation, SSD 15 can operate efficiently with less free memory space, in contrast to the case where the data pages are stored in a more random manner within the memory blocks causing fragmentation.

Arrays of memory cells in the data blocks need to be erased before the same memory cells can be reprogrammed with new data and cannot be over-written. As a result, the number of fresh data blocks decreases as new data is programmed, which affects the storage performance. To free up new memory space, “garbage collection” or compaction processes are used to move valid data stored in used memory blocks which are intermingled with invalid data pages to fresh memory blocks. The used memory blocks are then erased which increases the availability of fresh memory blocks for new data programming.

Typically, SSD 15 maintains a certain amount of over-provisioning, i.e., a reserve of fresh blocks that are not visible to the host and are not considered part of the free memory space. The over-provisioning overhead is used, for example, for enabling efficient compaction and as a replacement pool for failed blocks. SSD overprovisioning improves storage performance by providing SSD controller 40 with spare buffer memory space for managing the data stored on SSD 15. Typical levels of SSD over-provisioning are 4-6%, for example. Stated differently, the additional number of memory blocks kept in reserve for SSD data management processes, is 4-6% of the total number of memory blocks seen by the host.

The storage management processes performed by the SSD controller, e.g., garbage collection, incur additional internal write operations, beyond the external write operations initiated by the host. The ratio between the overall rate of write operations (internal and external) and the net rate of external write operations from the host is referred to as write amplification. Write amplification is a good indication of fragmentation: A highly fragmented memory incurs high write amplification, and vice versa. Write amplification also depends strongly on the over-provisioning ratio.

### Storage Device Performance Notification to Host

In some embodiments of the present invention disclosed herein, SSD 15 estimates the impact of the amount of free memory space on the storage performance. SSD 15 then sends a notification to host 20 indicative of the estimated impact. The notification may comprise any suitable SSD storage performance metric, which is sent by SSD 15 to host 20 so as to notify the host of the storage performance of the SSD.

Upon receiving the notification, the host may choose to implement any suitable action or processes to assist the SSD in improving its storage performance. In some embodiments, host 20 may alert the user that SSD 15 is not performing well, such that the user may decide to delete one or more data items in order to free up memory space and restore normal SSD operation.

In other embodiments, host 20 may identify non-critical data items stored on SSD 15 and selectively delete them. Non-critical data may comprise, for example, unused data, old backup versions of files, data from old versions of software applications, auto-save files, and the like. Further alternatively, the host may issue a “trim” command to the SSD, so as to free specified LBAs. In yet other embodiments, in response to receiving the notification, host 20 may rewrite existing data to sequential memory pages in memory devices in SSD 15 so as to reduce the level of fragmentation in SSD 15.

After the one or more data items are deleted, the next garbage collection iteration will remove copies of the deleted data, and thus increase the amount of free memory space that is available to SSD 15 to write new data.

In some embodiments, the SSD notifies the host of both the free memory space and the estimated impact. Based on the combination of these two parameters, the host is able to better decide whether corrective action is called for.

FIG. 2 is a flow chart that schematically illustrates a method for data storage management, in accordance with an embodiment of the present invention. In a storing step 100, host 20 stores data in SSD 15. In an estimating step 110, processor 50 of SSD controller 40 in storage device 15 estimates an impact of an amount of the free memory space on storage performance. Processor 50 may estimate, for example, the write amplification ratio, the number of bad memory blocks in Flash devices 70, the current over-provisioning ratio, or the extent of data fragmentation. Alternatively, processor 50 may estimate any other suitable measure, which is indicative of the impact of the amount of free memory space on storage performance.

In a sending step 130, SSD controller 40 sends host 20 a notification of the estimated impact on the storage performance. The notification may comprise, for example, an indication of one or more such measures (e.g., an indication of the write amplification, number of bad blocks, over-provisioning ratio and/or fragmentation), a flag indicating whether storage performance is adequate or not, or any other suitable type of notification.

The SSD controller may initiate the notification in response to any suitable condition or event, e.g., periodically, in response to detecting that the storage performance deteriorates below a certain threshold, in response to detecting that the storage performance improves above a certain threshold, or in response to a request from the host.

In a decision step 130, host 20 uses the notification to assess whether the storage performance is poor due to low free memory space. If not, host 20 continues to store new data on SSD 15 (storing step 100). Otherwise, host 20 deletes non-critical data items from the storage device, in a deleting step 140 so as to free up memory space and improve SSD 15 storage performance.

Although the embodiments described herein mainly address Flash memory systems, the methods described herein can also be used in computer systems comprising any other suitable storage device.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A method, comprising:
in a storage device that stores data for a host in a memory, estimating an impact of an amount of free memory space in the memory on a storage performance of the storage device; and
sending from the storage device to the host a notification that is indicative of the estimated impact.

2. The method according to claim 1, wherein estimating the impact comprises estimating a write amplification overhead occurring in the memory.

3. The method according to claim 1, wherein estimating the impact comprises assessing a number of bad memory blocks in the memory.

4. The method according to claim 1, wherein estimating the impact comprises estimating an over-provisioning overhead in the memory.

5. The method according to claim 1, wherein estimating the impact comprises estimating an extent of fragmentation in the data stored in the memory.

6. The method according to claim 1, wherein sending the notification comprises sending an indication of whether the storage performance is adequate.

7. The method according to claim 1, and comprising, in the host, deleting one or more data items from the storage device in response to the notification.

8. The method according to claim 1, and comprising, in response to the notification, sending from the host to the storage device a trim command that frees specified addresses in the storage device.

9. The method according to claim 1, and comprising, in response to the notification, rewriting data to sequential memory pages in the memory so as to reduce fragmentation in the storage device.

10. The method according to claim 1, wherein sending the notification comprises sending to the host a first notification indicative of the amount of free memory space, and a second notification indicative of the impact of the amount of free memory space on the storage performance.

11. A storage device, comprising:
a memory; and
a processor, which is configured to store data for a host in the memory, to estimate an impact of an amount of free memory space in the memory on a storage performance of the storage device, and to send to the host a notification that is indicative of the estimated impact.

12. The storage device according to claim 11, wherein the processor is configured to estimate the impact by estimating a write amplification overhead occurring in the memory.

13. The storage device according to claim 11, wherein the processor is configured to estimate the impact by estimating a number of bad memory blocks in the memory.

14. The storage device according to claim 11, wherein the processor is configured to estimate the impact by estimating an over-provisioning overhead in the memory.

15. The storage device according to claim 11, wherein the processor is configured to estimate the impact by estimating an extent of fragmentation in the data stored in the memory.

16. The storage device according to claim 11, wherein the notification comprises an indication of whether the storage performance is adequate.

17. The storage device according to claim 11, wherein the notification comprises a first notification indicative of the amount of free memory space, and a second notification indicative of the impact of the amount of free memory space on the storage performance.

18. A host, comprising:
a storage interface for communicating with a storage device; and
a processor, which is configured to store data in a memory of the storage device, to receive from the storage device a notification that is indicative of an estimated impact of an amount of free memory space in the memory on a storage performance of the storage device, and to selectively delete one or more data items from the storage device in response to the notification.
